(19) United States
(12) Patent Application Publication
(10) Pub. No.: US 2016/0126664 A1
(43) Pub. Date: May 5, 2016

(54) CONNECTOR PROVIDING COMBINED FASTENER AND RADIO FREQUENCY INTERFACE

(71) Applicant: MOTOROLA SOLUTIONS, INC, SCHAUMBURG, IL (US)

(72) Inventors: JORGE L. GARCIA, PLANTATION, FL (US); BASSAM I. YAZIGI, PEMBROKE PINES, FL (US)

(21) Appl. No.: 14/530,085

(22) Filed: Oct. 31, 2014

(51) Int. Cl. H01R 13/622; H01R 24/38

(52) U.S. Cl. CPC H01R 13/622; H01R 24/38

(57) ABSTRACT

A connector (100) provides both fastener and RF interface functionality. The connector (100) is formed of a top circular disk (102) having a threaded lead (104) extending therefrom. A through-hole extends from the circular disk through the threaded lead (104). An insulator (110) extends within the through-hole from top circular disk (102) through the threaded lead (104). An electronic contact (106) within the insulator (110) extends from the top circular disk (102) through the threaded lead (104). The electronic contact (106) is exposed at one end on a top surface (108) of the top circular disk (102) and is also exposed at the through-hole of the threaded lead (104).

### FIELD OF THE DISCLOSURE

The present disclosure relates generally to connectors and more particularly to connectors that provide a combination of functionality.

### BACKGROUND

Electronic products, such as portable radio products, utilize connectors and electronic interface devices as part of the radio assembly. Assembly apparatus often includes a variety of clips, springs, circuit boards, cables, flexes and adhesives making for a cumbersome and complex assembly. The ability to facilitate the assembly of a radio and reduce parts count is desirable. The characteristics of good contact, good sealing and ease of assembly are all important factors to consider when designing elements for an electrical product. In particular, the portable radio environment presents a challenge in that the connectors must be robust and take up little space. The ability of a connector to provide more than one function would improve assembly and provide reduced parts count and cost.

Accordingly, it would be desirable to have a connector providing a combination of features.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a connector formed in accordance with an embodiment;

FIG. 2 is a radio having the connector mounted thereto in accordance with an embodiment; and

FIG. 3 is a cut-away view of the radio having the connector fastening portions of the radio and providing an RF interface in accordance with an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Briefly, an improved connector providing a combined fastener and radio frequency (RF) interface is described herein. In accordance with the embodiments, the connector is shaped like a screw and provides an RF interface comprising an exposed RF contact at one end of the screw and an RF connector and the other end of the screw. A threaded lead portion of the connector provides screw-in insertion for fastening capability. The connector assembly does not require the use of spring, cable or clip elements.

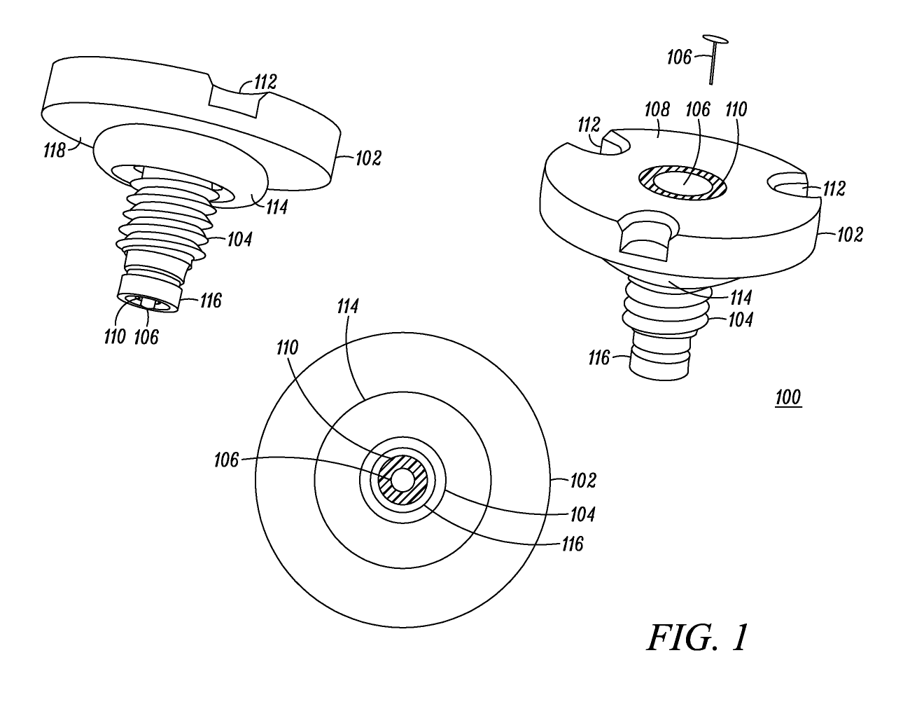

FIG. 1 is a connector 100 formed in accordance with an embodiment. Two isometric views and a bottom view are shown. The connector 100 is formed of a metal screw having a screw head 102, also referred to a top circular disk portion, and a threaded lead 104 extending therefrom. The connector 100 has a through-hole extending from the screw head 102 through the threaded lead 104 and an insulator 110 inserted within the through-hole. Insulator 110 may be formed of polyethylene (PTFE), polytetrafluoroethylene (PTFE) or other insulating material appropriate for RF signal insulation. An electronic contact 106 is insertably coupled through the through-hole within the insulator 110. The electronic contact 106 will also be referred to as a radio frequency (RF) contact 106. The electronic contact 106 has first and second ends extending lengthwise through the connector 100 within the insulator 110. The first and second ends of the RF contact 106 are exposed at each end of the screw. The top surface 108 of the screw 102 and exposed RF contact 106 provide an RF interface. The collar 116 and RF contact 106 provide another RF interface with the contact 106 providing the RF contact (hot) and the collar 116 providing the ground.

The electronic contact 106 is also shown separately, as a pin. However, depending on the application an RF socket could be used. The RF contact 106 and insulator 110 can be press fit into the through-hole of the connector 100, and can be retained therein with barbs or other retaining features which are known.

The connector 100 further comprises a plurality of recessed features 112 formed the top circular disk portion 102. These recessed features are formed as spanner recesses to allow connector 100 to be insertably screwed in using a spanner tool or the like. Alternatively, wing tabs could also be used in place of the recessed features 112, however the recessed features provide the advantages of space savings. An o-ring 114 can be added around the threaded lead 104 beneath a bottom surface 118 of the top circular disk portion 102, for sealing purposes. The insulator 110 may be formed of different portions or comprise more than one insulator dependent on the size and length of the connector's through-hole and the electronic contact 106.

The form factor provided by connector 100 allows for a very small overall component well suited to portable electronic products, such as radios other products using radio frequency circuitry. The connector 100 advantageously uses only a single threaded lead thereby allowing for the screw type form factor.

Prototype piece parts have been made having a disk diameter of 10 millimeters (mm), threaded lead diameter of 4 mm, and overall length of 7 mm. This miniaturized size makes the connector suitable for portable electronic products having limited space.

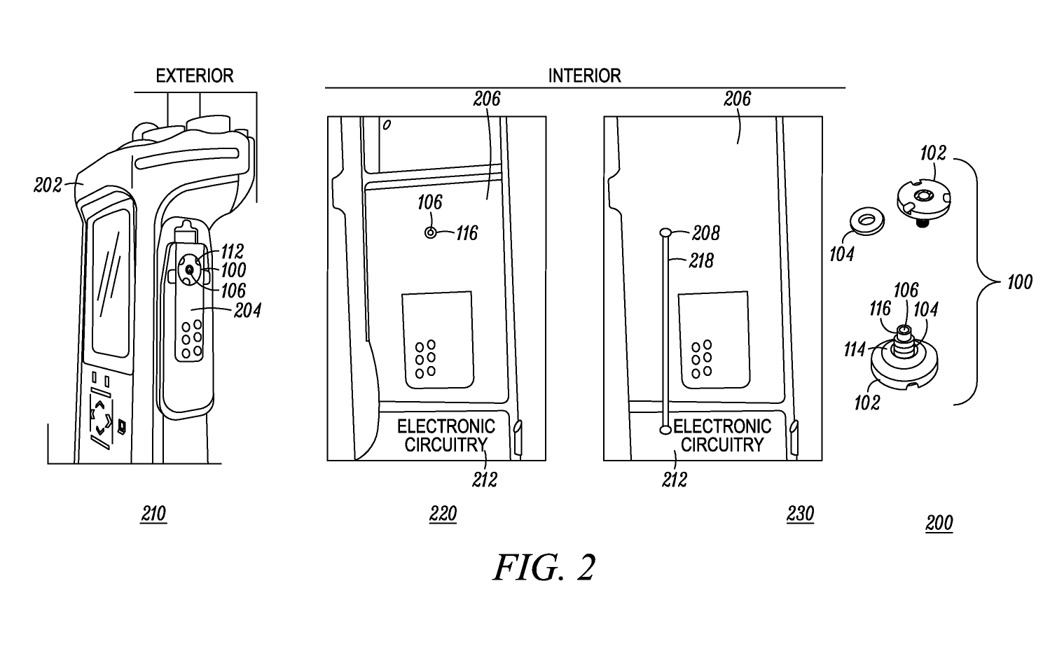

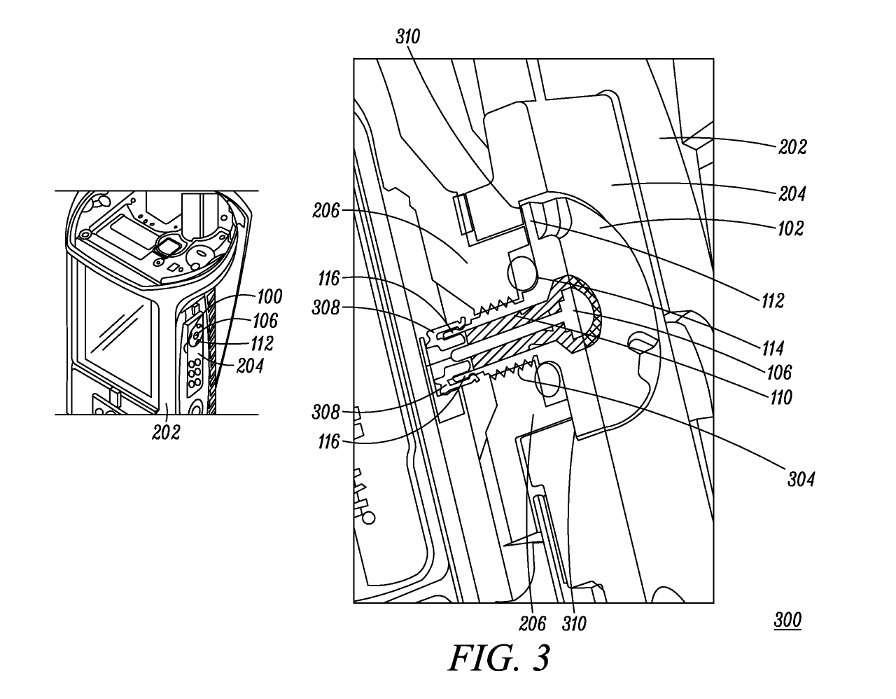

FIG. 2 is a radio 200 having the connector 100 mounted thereto accordance with an embodiment. Again, the connector 100 is formed as a metal screw having a screw head 102 and a threaded lead 104 with an RF contact 106 extending from the header through an interior portion of the threaded lead. Exterior radio view 210 and interior radio views 220, 230 are shown in FIG. 2. Radio 200 comprises a radio housing 202 having an exterior plastic contact header 204 and an interior metal radio chassis 206. In view 210, connector 100 is screwed into the radio 200 at plastic contact header 204. As will be shown in FIG. 3 the plastic header 204 has a recess flange area and through-hole within which to mount the screw head 102. In view 220, the interior of the radio is shown with the RF interface formed of collar 116 and RF contact 106 extending into the interior of the radio through the metal radio chassis 206. In view 230, the interior of the radio is shown with a radio coaxial connector 208 and cable 218 mated to the collar 116 and RF contact 106. Cable 218 is coupled to electronic RF circuitry 212.

Thus, connector 100 provides fastener capability coupling different portions of the radio together, via the top circular disk 102 and threaded lead 104. The single threaded lead 104 operates as a screw to provide fastening capability. The connector 100 further provides RF interface capability to the radio 200, via the collar 116 and RF contact 106 extending into the interior of the radio. Further RF interface capability is provided via the exterior of the radio housing via the top surface 108 of the circular disk 102 and the exposed RF contact 106.

FIG. 3 is a cut-away view 300 of the radio 200 having the connector 100 fastening portions of the radio and providing an RF interface in accordance with an embodiment. This view 300 facilitates showing how the connector 100 provides an improved electro-mechanical interconnect. In this view, radio 200 comprises radio housing 202 having an exterior portion and an interior portion. In accordance with this embodiment, the connector 100 couples a portion of the exterior of the radio 200, shown as plastic header 204, to a portion of the interior of the radio comprising a metal radio chassis 206. The recessed features 112 comprise spanner recess features that allow the connector to be easily screwed in with a spanner type tool.

The threaded lead 104 is screwed into corresponding threading of the radio metal radio chassis 206 thereby fastening the plastic header 204 to the metal radio chassis 206. The plastic header 204 comprises a flange recess 310 formed therein and within which the screw head is seated. The RF contact 106 extends lengthwise through the screw within the insulator 110, with the first and second ends of the RF contact being exposed at each end of the screw. The RF contact 106 being exposed on the exterior surface of the radio provides easy access. For example, external RF accessories can be coupled to the exposed RF interface. Additionally testing of internal RF radio circuits can be made without opening the radio housing by accessing the exposed RF contact 106. The coaxial interface provided by connector 100 at contact 106 and collar 116 mate with a corresponding radio coaxial connector 308 internal to the radio. Radio coaxial connector 308 shown in FIG. 3 is basically a side, cut-away view of the coaxial connector 208 from FIG. 2.

The coaxial interface of the connector 100 provides the male interface while the radio connector 308 provides a female interface. The radio coaxial connector 308 is further coupled to radio frequency circuitry (not shown). It is further anticipated that the male and female interconnect aspects can be switched such that the connector 100 provides the female coaxial interconnect portion and the radio coaxial connector provides a corresponding male coaxial interconnect portion. In other words, the pin and socket configuration could be swapped with the socket portion being within an insulator within the screw and the pin portion being within a corresponding connector of the radio housing.

The 114 o-ring coupled around the threaded screw portion beneath the top screw portion forms a seal between the plastic header 204 and the metal radio chassis 206. Thus, connector 100 formed in accordance with the embodiments, provides a fastener, an RF interface, and sealing. The RF interface provides RF access interior to the radio and exterior to the radio. Accessories or testing equipment can be mounted to the exterior RF interface. Thus, the connector 100 provides a plurality of functional features.

Accordingly, the embodiments have described a connector providing for an improved electro-mechanical interconnect. The connector 100 eliminates the use of printed circuit boards, clips and adhesives thereby facilitating assembly of an electronic product, such as a portable radio, using a single threaded lead 104 extending from the top circular disk 102. The ability of the connector to provide more than one function not only improves assembly and provides reduced parts count and cost but also provides the ability to couple external RF accessories to the exposed contact 106 or test the radio at that point without taking apart the radio housing. The o-ring provides sealing to further ensure the radio is protected in rugged environments.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A connector, comprising:
a circular disk having top and bottom surfaces, the bottom surface having a threaded lead extending therefrom, the circular disk and threaded lead being formed of a conductive material;
an insulator sleeve extending from the top surface of the circular disk through the threaded lead; and
an electronic contact exposed on the top surface of the circular disk and extending down through the threaded lead within the insulated sleeve.

2. The connector of claim 1, wherein the electronic contact comprises an impedance interface contact and the circular disk with threaded lead extending therefrom is operable as a ground reference.

3. The connector of claim 2, wherein connector provides both fastener capability through the threaded lead, and the connector provides RF interface capability through the electronic contact and ground reference.

4. The connector of claim 1, wherein the electronic contact provides a 50-ohm interface contact and the circular disk with threaded lead extending therefrom operates as a ground reference.

5. The connector of claim 1, wherein the circular disk further comprises recessed features.

6. The connector of claim 1, further comprising a seal coupled around the threaded lead at the bottom surface of the circular disk.

7. The connector of claim 1, wherein the circular disk and the threaded lead extending therefrom are formed as a single metal piece part having the electronic contact press fit within the insulator.

8. A connector comprising:
a metal screw having a screw head and a threaded lead extending therefrom;
a through-hole extending from the screw head through the threaded lead; and
an insulator inserted within the through-hole; and
an electronic contact being coupled through the through-hole within the insulator, the electronic contact having first and second ends, the first end being exposed at the screw head and the second end being exposed within the threaded lead.

9. The connector of claim 8, wherein the connector provides both a fastener and a radio frequency (RF) interface.

10. The connector of claim 8, further comprising an o-ring coupled between the screw head and threaded lead.

11. The connector of claim 8, further comprising spanner recess features formed in the screw head.

12. The connector of claim 8, wherein the electronic contact comprises a radio frequency (RF) contact, and the threaded lead extends into a collar portion providing a ground, the collar portion and RF contact providing an RF connector.

13. A radio, comprising:
a radio housing having an exterior portion and an interior portion, the interior portion comprising a metal chassis and a coaxial connector coupled to radio circuitry; and
a metal screw coupling the exterior portion of the radio to the metal casting, the metal screw providing a radio frequency (RF) contact and ground interface for mating with the RF coaxial connector of the radio.

14. The radio of claim 13, wherein the RF contact of the screw is also exposed on the exterior portion of the radio housing.

15. The radio of claim 13, wherein the exterior portion comprises a plastic contact header.

16. The radio of claim 13, wherein the RF contact has first and second ends, the RF contact extending lengthwise through the screw within an insulator, the first and second ends of the RF contact being exposed at each end of the screw.

17. The radio of claim 13, further comprising an o-ring coupled between the screw and the metal chassis.

18. The radio of claim 14, wherein the RF contact exposed on the exterior portion of the radio housing provides an external RF test point for the radio and an access point for mounting external RF accessories.

19. The radio of claim 13, wherein the screw further comprises spanner recess features.

20. The radio of claim 13, wherein the metal chassis of the radio comprises threading within which to screw in the screw.
